(19) United States
(12) Patent Application Publication
(10) Pub. No.: US 2020/0056608 A1
(43) Pub. Date: Feb. 20, 2020

(54) SEALING STRUCTURE OF PLUNGER PUMP

(71) Applicants: Xiaorong Li, Taizhou (CN); Fazheng Yang, Taizhou (CN)

(72) Inventors: Xiaorong Li, Taizhou (CN); Fazheng Yang, Taizhou (CN)

(21) Appl. No.: 16/198,897

(22) Filed: Nov. 23, 2018

(30) Foreign Application Priority Data
Aug. 15, 2018 (CN) 201821311040.8

(51) Int. Cl. F04B 53/14; F16J 15/3232; F16J 15/00

(52) U.S. Cl. CPC F04B 53/143; F16J 15/002; F16J 15/3232

(57) ABSTRACT

A sealing structure of plunger pump, comprising a pump body, a feed chamber, an oil, a suited plunger; wherein the plunger includes a one-way valve and a discharge hole; the feed chamber includes a mounting step having a first sealing ring, a second sealing ring; an inner wall of the first sealing ring has a plurality of first sealing pipes distributed uniformly in longitudinal direction; an infusion step having an annular mounting groove; the mounting groove is embedded with a suited spring leaf; an inner wall of the second sealing ring includes a plurality of sealing toothed rings. The sealing structure of the plunger pump can ensure the sealing effect of the sealing ring when the sealing ring is worn out, and can ensure the service life of the sealing ring to the utmost extent.

### BACKGROUND OF INVENTION

### 1. Field of the Invention

The present invention relates generally to a sealing structure of plunger pump.

### 2. Description of Related Art

The airless spraying refers to a spray coating method using high pressure plunger pump to pressurize paint directly to form highly compressed paint, which is sprayed out of the muzzle to form atomized airflow acting on the body surface. Therefore, the sealing effect of plunger pump is of great importance, once the plunger pump sealing is poor, there will be oil leak, leading to unstable pressure, influencing the spray coating effect and spray coating quality. There is only one sealing ring fitted over the plunger of conventional plunger pump, and this sealing ring is a general ring washer, as the plunger shifts longitudinally in a long period of time, the plunger is always pulling the sealing ring, the sealing ring is worn. There will be a clearance between the inner wall of sealing ring and the outer wall of plunger, so that the paint leaks, and such a long-term pull on the sealing ring is likely to induce elastic failure of sealing ring, the sealing effect of plunger pump cannot be guaranteed for long.

In the spray coating process of paint, the paint is very likely to contain particulate matter, this particulate matter is very likely to be stuck between the inner wall of sealing ring and the outer wall of plunger, leading to a clearance between them and leak.

### SUMMARY OF THE INVENTION

The, present invention provides a seal structure of plunger pump, which can guarantee the sealing effect of sealing ring when the sealing ring is worn, and can guarantee the service life of sealing ring to maximum extent.

In order to solve the above technical problems, the present invention adopts the following technical solutions:

A sealing structure of plunger pump, comprising: a pump body, a feed chamber located in pump body and an oil line connected to feed chamber; a suited plunger is located in feed chamber;

wherein the plunger includes a one-way valve and a discharge hole matching the one-way valve; the one-way valve is located near the connection between feed chamber and oil line; an upper inner wall of the feed chamber includes a mounting step; the mounting step includes a first sealing ring, the first sealing ring is fitted over the plunger; a second sealing ring is disposed above the first sealing ring and the second sealing ring is sleeved outside the plunger an inner wall of the first sealing ring has a plurality of first sealing pipes distributed uniformly in longitudinal direction; the first sealing pipes are integrally formed with the first sealing ring; the first sealing pipes are wide-top narrow-bottom hole shaped; the first sealing pipes and the inner wall of the first sealing ling are enclosed to form a plurality of first storage tanks distributed uniformly in longitudinal direction; an infusion step is located on a lower surface of the second sealing ring corresponding to the first sealing pipes; the infusion step has an annular mounting groove; the mounting groove is embedded with a suited spring leaf; an inner wall of the second sealing ring includes a plurality of sealing toothed rings distributed uniformly in longitudinal direction; the sealing toothed ring closer to the first sealing ring has smaller bore diameter.

Compared with the existing technology, the first sealing ring and the second sealing ring of the sealing structure of plunger pump of the present invention form dual sealing, and the first sealing ring is assisted by the first sealing pipe, the second sealing ring is assisted by the mounting groove, the higher the received paint pressure is, the better is the sealing performance between the first sealing pipe and the second sealing pipe and the plunger, and the first storage tank can prevent the clearance formed by particulate matter effectively, the spring leaf can prolong the service life of the second sealing ring effectively, so as to guarantee the sealing effect and service life of the sealing structure of plunger pump.

### BRIEF DESCRIPTION OF THE DRAWINGS

FIG. 1 is a structural representation of a sealing structure of plunger pump of the present invention;

FIG. 2 is an enlarged view of Part A in FIG.1;

FIG. 3 is an enlarged view of Part B in FIG. 2.

### DETAILED DESCRIPTION OF THE INVENTION

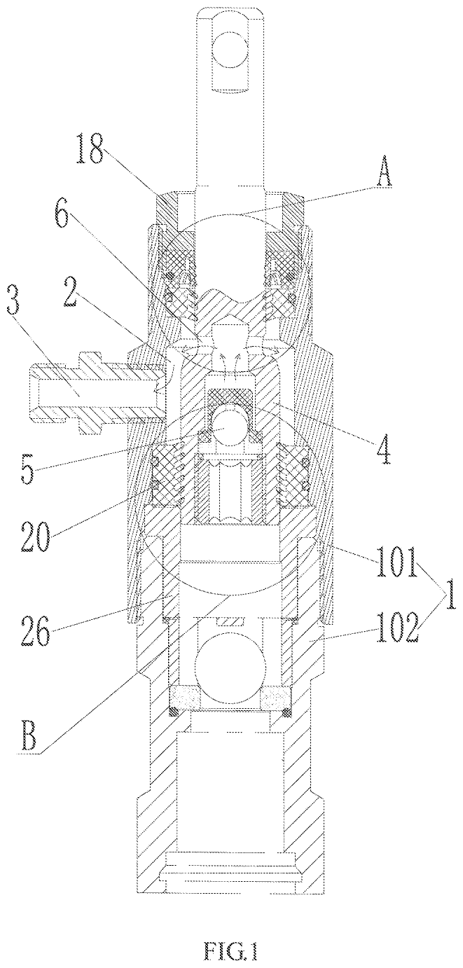

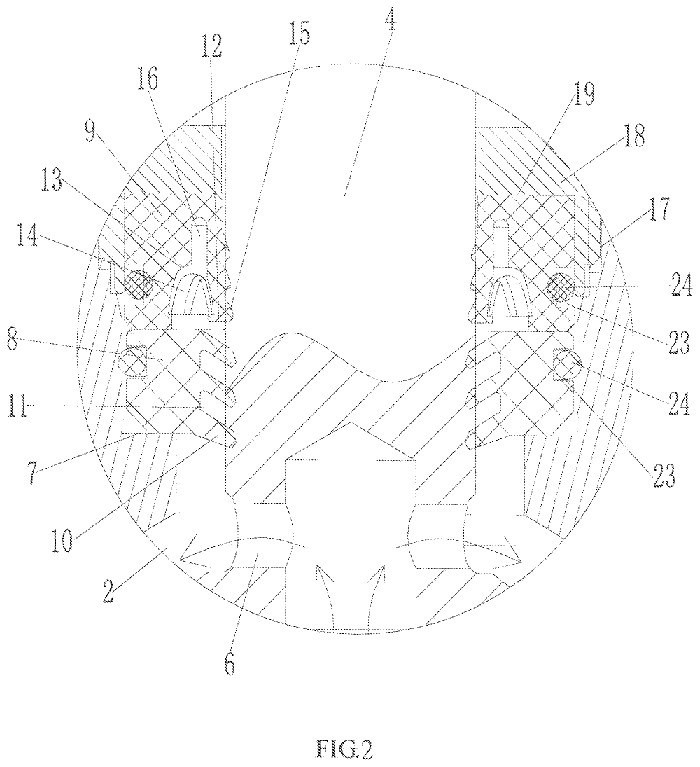

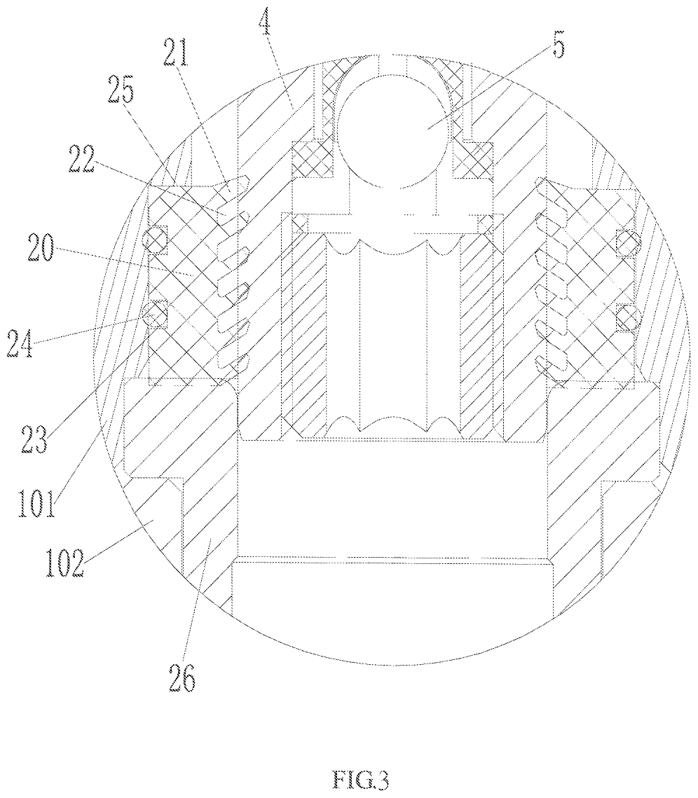

FIG. 1 to FIG. 3 show a sealing structure of plunger pump, comprising a pump body 1, a feed chamber 2 located in pump body 1 and an oil line 3 connected to feed chamber 2. A suited plunger 4 is located in feed chamber 2. The plunger 4 includes a one-way valve 5 and a discharge hole 6 matching one valve 5. The one-way valve 5 is located near the connection between feed chamber 2 and oil line 3. The upper inner wall of the feed chamber 2 includes a mounting step 7. The mounting step 7 includes a first sealing ring 8, the first sealing ring 8 is fitted over plunger 4. A second sealing ring 9 adhering to the first sealing ring 8 is located above it. The second sealing ring 9 is fitted over plunger 4. The inner wail of the first sealing ring 8 includes a plurality of first sealing pipes 10 distributed uniformly in longitudinal direction. The first sealing pipes 10 and the first sealing ring 8 are molded in one. The first sealing pipes 10 are narrow-bottom, wide-top hole shaped. The first sealing pipes 10 and the inner wall of the first sealing ring 8 are enclosed to form a plurality of first storage tanks 11 distributed uniformly in longitudinal direction. An infusion step 12 is located on the lower surface of the second sealing ring 9 corresponding to the first sealing pipes 10. The infusion step 12 includes an annular mounting groove 13. A suited spring leaf 14 is fixed in mounting groove 13. The inner wall of the second sealing ring 9 includes a plurality of sealing toothed rings 15 distributed uniformly in longitudinal direction. The sealing toothed ring 15 closer to the first sealing ring 8 has smaller bore diameter.

An auxiliary groove 16 connected to mounting groove 13 is located in the second sealing ring 9, the auxiliary groove 16 is annular.

The cross section of the mounting groove 13 and the cross section of spring leaf 14 are inverted V-shaped.

The upper end of the pump body 1 includes a bolt hole 17 connected to feed chamber 2. A locknut 18 is screwed in the bolt hole 17. The lower surface of the locknut 18 includes a fixed step 19. The second sealing ring 9 is clamped in the fixed step 19. The locknut 18 squeezes the first sealing ring on the mounting step 7 via the second sealing ring 9.

A third sealing ring 20 is located in the middle of the feed chamber 2. The third sealing ring 20 is fitted over plunger 4. The third sealing ring 20 and the first sealing ring 8 are located below and above the discharge hole 6 respectively. The inner wall of the third sealing ring 20 includes a plurality of second sealing pipes 21 distributed uniformly in longitudinal direction. The second sealing pipes 21 and the third sealing ring 20 are molded in one. The second sealing pipes 21 are wide-top narrow-bottom flaring. The second sealing pipes 21 and the inner wall of the third sealing ring 20 are enclosed to form a plurality of second storage tanks 22 distributed uniformly in longitudinal direction.

The outer walls of the first sealing ring 8, the second sealing ring 9 and the third sealing ring 20 include a plurality of ring grooves 23 distributed uniformly in longitudinal direction. The suited O-rings 24 are fixed in the ring grooves 23.

The pump body 1 comprises an upper case 101 and a lower case 102. The upper case 101 and lower case 102 are screwed together. The lower inner wall of the upper case 101 includes a restraining step 25. The upper end of the lower case 102 includes a bracket 26, the third sealing ring 20 is stuck between restraining step 25 and bracket 26.

The usage of the present invention is described below:

During airless spraying, the one-way valve is turned on under the effect of paint pressure, the paint flows through the one-way valve 5 and out of discharge hole 6 to enter the feed chamber 2. As the paint is fed into the feed chamber 2 continuously the paint enters the oil line 3, and then it is atomized and sprayed for spray coating.

When the feed chamber 2 is filled up with paint, under the pressure effect, the paint extrudes the first sealing pipes 10 on the inner wall of the first sealing ring 8 upward, the bottommost first sealing pipe 10 contacts the paint, the first sealing pipes 10 receiving the upward extrusion pressure deform upward accordingly. As the first sealing pipes 10 are wide-top narrow-bottom hole shaped, when the first sealing pipes 10 deform upward, the inside diameter of the first sealing pipes 10 decreases, the first sealing pipes 10 adhere to the outer wall of plunger 4 more tightly. Even if one side of the first sealing pipes 10 adhering to plunger 4 is worn due to long-term friction, as the first sealing pipes 10 expand towards plunger 4 under the effect of paint, the sealing performance between the first sealing ring 8 and plunger 4 can be guaranteed all along. Even if the paint contains particulate matter, the particulate matter is pushed in the first storage tanks 11 directly under the paint pressure effect, so that the particulate matter cannot influence the adherence between the first sealing pipes 10 and plunger 4, the sealing performance between the first sealing ring 8 and plunger 4 is guaranteed to maximum extent.

If some paint leaks upward through the first sealing ring 8, the second sealing ring 9 forms the second sealing. As an infusion step 12 is located on the lower surface of the second sealing ring 9 corresponding to the first sealing pipes 10, once the paint leaks to the upper surface of the first sealing ring 8, the paint enters the infusion step 12, and the gap formed in the infusion step 12 can lead the paint in the mounting groove 13 within the shortest time, the paint pressure acts on the mounting groove 13, the mounting groove 13 is expanded, and the second sealing ring 9 is pulled off. As the second sealing ring 9 is pulled off, the second sealing ring 9 adheres to the plunger 4 more tightly. The spring leaf 14 can effectively share the pressure received when the second sealing ring 9 deforms, to avoid the excessive pressure inducing elastic failure of the second sealing ring 9, the service life of the second sealing ring 9 is guaranteed, and the sealing toothed rings 15 further enhance the sealing performance between the second sealing ring 9 and plunger 4.

To sum up, the first sealing ring 8 and the second sealing ring 9 of the present invention can form dual sealing, and the first sealing ring 8 is assisted by the first sealing pipes 10, the second sealing ring 9 is assisted by mounting groove 13, the higher the received paint pressure is, the better is the sealing performance between the first sealing pipes 10 and the second sealing pipes 21 and the plunger 4. The first storage tanks 11 can prevent the clearance formed by particulate matter effectively, the spring leaf can prolong the service life of the second sealing ring 9 effectively, so as to guarantee the sealing effect and service life of the sealing structure of plunger pump.

An auxiliary groove 16 connected to mounting groove is located in the second sealing ring 9, the auxiliary groove 16 is annular. The auxiliary groove 16 can further enhance the elasticity of the second sealing ring 9, and it is favorable for the deformation of the second sealing ring 9, the augmentation of the second sealing ring 9 is increased, the sealing effect of the second sealing ring 9 is further enhanced.

The cross section of mounting groove 13 and the cross section of spring leaf 14 are inverted V-shaped, this shape is more favorable for the concentration of paint pressure, so that the paint pressure can act on the mounting groove 13 within the shortest time, the sealing efficiency of the second sealing ring 9 is enhanced.

The upper end of pump body 1 includes a bolt hole 17 connected to feed chamber 2, a locknut 18 is screwed in the bolt hole 17. The lower surface of locknut 18 includes a fixed step 19. The second sealing ring 9 is clamped in the fixed step 19. The locknut 18 squeezes the first sealing ring 8 on the mounting step 7 via the second sealing ring 9. To repair or change the first sealing ring 8 or the second sealing ring 9, as long as the locknut 18 is screwed out, the first sealing ring 8 and the second sealing ring 9 can be mounted and dismounted rapidly, favorable for repair and change.

A third sealing ring 20 is located in the middle of feed chamber 2. The third sealing ring 20 is fitted over the plunger 4. The third sealing ring 20 and the first sealing ring 8 are located below and above the discharge hole 6 respectively. The inner wall of the third sealing ring 20 includes a plurality of second sealing pipes 21 distributed uniformly in longitudinal direction. The second sealing pipes 21 and the third sealing ring 20 are molded in one. The second sealing pipes 21 are wide-top narrow-bottom flaring. The second sealing pipes 21 and the inner wall of the third sealing ring 20 are enclosed to form a plurality of second storage tanks 22 distributed uniformly in longitudinal direction. The third sealing ring 20 guarantees the sealing performance of the lower part of plunger 4. The third sealing ring 20 and the first sealing ring 8 and the second sealing ring 9 are used jointly, the sealing degrees of the upper and lower parts of plunger 4 can be guaranteed simultaneously, so as to further guarantee the sealing effect of the seal structure, of plunger pump. The second sealing pipes 21 have the same effect of the first sealing pipes 10. The second storage tanks 22 have the same effect of the first storage tanks 11.

The outer walls of the first sealing ring 8, the second se mg ring 9 and the third sealing ring 20 include a plurality of ring grooves 23 distributed uniformly in longitudinal direction. The ring grooves 23 are embedded with suited O-rings 24, the O-rings 24 further enhance the sealing performance of the first sealing ring 8, the second sealing ring 9, the third sealing ring 20 and feed chamber 2.

The pump body 1 comprises an upper case 101 and a lower case 102. The upper case 101 and lower case 102 are screwed together. The lower in r wall of upper case 101 includes a restraining step 25. This structure is favorable for mounting and dismounting the third sealing ring 20, facilitating the repair and change of the third sealing ring 20. The upper end of pump body 1 includes a bracket 26. The third sealing ring 20 is stuck between restraining step 25 and bracket 26. The bracket 26 prevents wear.

The above only describes some exemplary embodiments of the present invention. Those having ordinary skills in the art may also make many modifications and improvements without departing from the conception of the invention, which shall all fall within the protection scope of the invention.

We claim:

1. A sealing structure of plunger pump, comprising:
a pump body, a feed chamber located in the pump body and an oil line connected to the feed chamber; a suited plunger is located in the feed chamber;
wherein the plunger includes a one-way valve and a discharge hole matching the one-way valve; the one-way valve is located near the connection between the feed chamber and the of line; an upper inner wall of the feed chamber includes a mounting step; the mounting step includes a first sealing ring, the first sealing ring is fitted over the plunger; a second sealing ring is disposed above the first sealing ring and the second sealing ring is sleeved outside the plunger; an inner wall of the first sealing ring has a plurality of first sealing pipes distributed uniformly in longitudinal direction; the first sealing pipes are integrally formed with the first sealing ring; the first sealing pipes are wide-top narrow-bottom hole shaped; the first sealing pipes and the inner wall of the first sealing ring are enclosed to form a plurality of first storage tanks distributed uniformly in longitudinal direction; an infusion step is located on a lower surface of the second sealing ring corresponding to the first sealing pipes; the infusion step has an annular mounting groove; the mounting groove is embedded with a suited spring leaf; an inner wall of the second sealing ring includes a plurality of sealing toothed rings distributed uniformly in longitudinal direction; the sealing toothed ring closer to the first sealing ring has smaller bore diameter.

2. The seal structure of plunger pump according to claim 1, wherein the second sealing ring includes an auxiliary groove extending through the mounting groove, and the auxiliary groove is annular.

3. The sealing structure of plunger pump according to claim 1, wherein the cross section of the mounting groove and the cross section of spring leaf are inverted V-shaped.

4. The sealing structure of plunger pump according to claim 1, wherein an upper end of the pump body includes a bolt hole connected to the feed chamber; a locknut is screwed in the bolt hole; a lower surface of the locknut includes a fixed step, the second sealing ring is clamped in the fixed step; the locknut presses the first sealing ring against the mounting step through the second sealing ring.

5. The sealing structure of plunger pump according to claim 1, wherein a third sealing ring is located in a middle of the feed chamber; the third sealing ring is fitted over the plunger; the third sealing ring and the first sealing ring are located below and above the discharge hole respectively; the inner wall of the third sealing ring includes a plurality of second sealing pipes distributed uniformly in longitudinal direction; the second sealing pipes and the third sealing ring are molded in one; the second sealing pipes are wide-top narrow-bottom flaring; the second sealing pipes and the inner wall of the third sealing ring are enclosed to form a plurality of second storage tanks distributed uniformly in longitudinal direction.

6. The sealing structure of plunger pump according to claim 5, wherein outer walls of the first sealing ring, the second sealing ring and the third sealing ring include a plurality of ring grooves distributed uniformly in longitudinal direction; the ring grooves are embedded with suited O-rings.

7. The sealing structure of plunger pump according to claim 1, wherein the pump body includes an upper case and a lower case; the upper case and lower case are screwed together; the lower inner wall of the upper case includes a restraining step; the upper end of the lower case includes a bracket, the third sealing ring is stuck between the restraining step and the bracket.
